(19) United States
(12) Patent Application Publication
(10) Pub. No.: US 2025/0066885 A1
(43) Pub. Date: Feb. 27, 2025

(54) GRAIN-ORIENTED ELECTRICAL STEEL SHEET, AND MANUFACTURING METHOD THEREFOR

(71) Applicant: POSCO CO., LTD, Gyeongsangbuk-do, Pohang-si (KR)

(72) Inventors: Kyungjun Ko, Pohang-si, Gyeongsangbuk-do (KR); Sangwoo Lee, Pohang-si, Gyeongsangbuk-do (KR)

(73) Assignee: POSCO CO., LTD, Gyeongsangbuk-do, Pohang-si (KR)

(21) Appl. No.: 18/721,099

(22) PCT Filed: Dec. 1, 2022
(86) PCT No.: PCT/KR2022/019322

§ 371 Date: Jun. 17, 2024

(30) Foreign Application Priority Data
Dec. 21, 2021 (KR) 10-2021-0184134

(51) Int. Cl. C22C 38/02; C21D 6/00; C21D 8/12; C21D 9/46; C22C 38/00; C22C 38/04; C22C 38/06; C22C 38/24; C22C 38/28; C22C 38/60; C23C 8/26

(52) U.S. Cl. CPC C22C 38/02; C21D 6/008; C21D 8/1222; C21D 8/1233; C21D 8/1272; C21D 9/46; C22C 38/001; C22C 38/008; C22C 38/04; C22C 38/06; C22C 38/24; C22C 38/28; C22C 38/60; C23C 8/26; C21D 2201/05

(57) ABSTRACT

A method for manufacturing a grain-oriented electrical steel sheet, according to one embodiment of the present invention, comprises the steps of: hot rolling a slab so as to manufacture a hot rolled sheet, the slab comprising, by wt %, 2.5-4.0% of Si, 0.03-0.09% of C, 0.015-0.040% of Al, 0.04-0.15% of Mn, 0.01% or less of S (excluding 0%), 0.002-0.012% of N, 0.01-0.05% of Sb, 0.03-0.1% of Sn, 0.05-0.2% of Cr and the balance of Fe and inevitable impurities; cold rolling the hot rolled sheet so as to manufacture a cold rolled sheet; and performing secondary recrystallization annealing on the steel sheet having undergone primary recrystallization annealing.

### TECHNICAL FIELD

An exemplary embodiment of the present invention relates to a grain-oriented electrical steel sheet and a method for manufacturing the same. More particularly, an exemplary embodiment of the present invention relates to a grain-oriented electrical steel sheet in which a ratio of hysteresis loss to the total iron loss is dramatically reduced by controlling an exposure time to nitriding gas during primary recrystallization annealing, and a method for manufacturing the same.

### BACKGROUND ART

A grain-oriented electrical steel sheet is used as an iron core material for stopping devices such as a transformer, an electric motor, a generator, and other electronic devices. Since a grain-oriented electrical steel sheet final product has a texture in which an orientation of grains is oriented in a (110)[001] direction and has extremely excellent magnetic properties in a rolling direction, the grain-oriented electrical steel sheet final product may be used as an iron core material for a transformer, an electric motor, a generator, other electronic devices, and the like, and is required to have low iron loss to reduce energy loss and a high magnetic flux density to reduce a size of power generation equipment.

The iron loss of the grain-oriented electrical steel sheet is divided into hysteresis loss and eddy current loss, and efforts such as increasing intrinsic resistivity and reducing a thickness of a product sheet are required to reduce the eddy current loss among them. In a method for reducing the thickness of the product sheet, there is a difficulty in rolling the grain-oriented electrical steel sheet, which is a product that is difficult to roll, into an ultra-thin material. In addition, a problem which is the biggest difficulty and needs to be overcome in manufacturing an ultra-thin material product having a significantly low iron loss is that as the thickness becomes thinner, it is difficult to significantly strongly maintain integration of Goss orientation, which is a secondary recrystallized structure of the grain-oriented electrical steel sheet. The hysteresis loss increases as movement of a magnetic domain wall is inhibited by fine precipitates or inclusions. A base material of the final product should be managed to be clean with minimal components such as C, N, O, and S, and as the Goss integration is stronger, the hysteresis loss is proportionally reduced.

This is because as the thickness of the product becomes thinner, the loss of precipitates from the surface during a secondary recrystallization annealing process, particularly, in a section where secondary recrystallization in the Goss orientation occurs, accelerates, which makes it difficult to maintain the strong Goss orientation integration. This is a problem directly related to magnetic properties of the product, which makes it difficult to secure significantly low iron loss characteristics even when the thickness is significantly thin.

In addition, as the product becomes thinner, a proportion of a coating layer in the entire product thickness increases. As a metal oxide layer (base coating or glass coating) on the base material becomes thicker, the proportion of the coating layer in the product may increase and hysteresis loss may be deteriorated.

As a method to overcome precipitate loss, a method of preventing precipitate loss by increasing a fraction of N₂ gas during the secondary recrystallization annealing process has been proposed, but this has a problem of causing surface defects such as nitrogen discharge holes on the surface of the product sheet.

An economical manufacturing method using a simultaneous decarburization and nitriding method has also been proposed. In manufacturing a decarburized sheet using the simultaneous decarburization and nitriding method, it was specified that there was a difference between a surface grain size and a center layer grain size, and it was suggested that this needed to be controlled within a certain range.

A technique to dramatically improve magnetism by containing segregation elements such as Sb, Sn, and P has also been proposed. The segregation elements were used as auxiliary inhibitors to compensate for the loss of precipitates when manufacturing the ultra-thin material product by further adding segregation elements. However, when an excessive amount of the segregation elements was added, ultra-thin rolling was difficult, the oxide layer became non-uniform and thin, which deteriorated the characteristics of the base coating, and thus, a side effect of further causing the loss of precipitates was caused, and as a result, magnetism was not stably secured.

A method of controlling an oxidation capacity and a nitriding treatment of a front end portion in the primary recrystallization annealing process when manufacturing an ultra-thin material product has also been proposed. However, when an ultra-thin material product was manufactured, there was a problem that the effect of the loss of precipitates became significantly sensitive.

In addition, a method of adding Cr to a slab and controlling the amount of nitriding gas added at front end and rear end portions in the primary recrystallization annealing process has also been proposed. However, this method maintained a uniform amount of nitrogen in a thickness direction of the steel sheet, but there was a problem in that AlN precipitates were distributed unevenly and a deviation in magnetic properties still existed. In addition, as Cr is added, a depth of the oxide layer deepens, a thickness of the base coating increases, and hysteresis loss of the thin material product in which a proportion of the coating layer increases in the product increases.

During the primary recrystallization annealing, decarburization and nitriding reactions occur through the surface layer portion of the steel sheet. In this case, a speed and timing of decarburization and nitriding change depending on the shape of the oxide layer formed in the surface layer portion. The depth and composition of the oxide layer formed during the primary recrystallization annealing process change sensitively depending on a furnace atmosphere such as a temperature and an oxidation capacity, a steel component content, a surface shape, and the like. In particular, components such as Sb, Sn, and Cr change oxide layer formation behavior depending on the amount added and consequently affect the characteristics of the product, and thus, it is required to derive optimal conditions according to the product characteristics.

### DISCLOSURE

### Technical Problem

An exemplary embodiment of the present invention provides a grain-oriented electrical steel sheet and a method for manufacturing the same. Specifically, an exemplary embodiment of the present invention provides a grain-oriented electrical steel sheet in which a ratio of hysteresis loss to the total iron loss is dramatically reduced by controlling an exposure time to nitriding gas during primary recrystallization annealing, and a method for manufacturing the same.

### Technical Solution

An exemplary embodiment of the present invention provides a method for manufacturing a grain-oriented electrical steel sheet, the method including: manufacturing a hot-rolled sheet by hot rolling a slab containing, by wt %, 2.5 to 4.0% of Si, 0.03 to 0.09% of C, 0.015 to 0.040% of Al, 0.04 to 0.15% of Mn, 0.01% or less (excluding 0%) of S, 0.002 to 0.012% of N, 0.01 to 0.05% of Sb, 0.03 to 0.1% of Sn, 0.05 to 0.2% of Cr, and a balance of Fe and inevitable impurities; manufacturing a cold-rolled sheet by cold rolling the hot-rolled sheet; subjecting the cold-rolled sheet to primary recrystallization annealing; and subjecting the steel sheet subjected to the primary recrystallization annealing to secondary recrystallization annealing.

The subjecting of the cold-rolled sheet to the primary recrystallization annealing includes: measuring the amount of nitriding of the steel sheet after the primary recrystallization annealing; and controlling an exposure time to nitriding gas during the primary recrystallization annealing according to the measured amount of nitriding, and the amount of nitriding and the exposure time to the nitriding gas satisfy the following Expression 1.

### [Expression 1]

Δ[N]/Δt≥0.025
(In Expression 1, Δ[N] represents the amount (wt %) of nitriding of the steel sheet after the primary recrystallization annealing, and Δt represents the exposure time (minutes) to the nitriding gas.)

The slab may further contain one or more of Ti and V in an amount of 0.002 to 0.01 wt % alone or as a mixture.

The slab may further contain 0.01 to 0.05 wt % of Sb, 0.03 to 0.1 wt % of Sn, and Cr, and may satisfy the following Expression 2.

### [Expression 2]

[Sb]≤[Cr]≤[Sb]+2×[Sn]
   (In Expression 2, [Sb], [Cr], and [Sn] represent contents (wt %) of Sb, Cr, and Sn in the slab, respectively.)

The subjecting of the cold-rolled sheet to the primary recrystallization annealing may be performed in an atmosphere having an oxidation capacity (PH₂O/PH₂) of 0.5 to 0.8.

The subjecting of the cold-rolled sheet to the primary recrystallization annealing may be performed at a temperature of 800 to 900° C.

After the subjecting of the cold-rolled sheet to the primary recrystallization annealing, an oxide layer having an average thickness of 1.6 to 3.2 μm may be present on a surface of the steel sheet.

After the subjecting of the cold-rolled sheet to the primary recrystallization annealing, the amount of nitriding of the steel sheet may be 0.02 to 0.04 wt %.

Another exemplary embodiment of the present invention provides a grain-oriented electrical steel sheet including: a base material containing, by wt %, 2.5 to 4.0% of Si, 0.005% or less (excluding 0%) of C, 0.015 to 0.040% of Al, 0.04 to 0.15% of Mn, 0.01% or less (excluding 0%) of S, 0.005% or less (excluding 0%) of N, 0.01 to 0.05% of Sb, 0.03 to 0.1% of Sn, 0.05 to 0.2% of Cr, and a balance of Fe and inevitable impurities; and a metal oxide layer located on the base material.

A maximum (Max) emission intensity ratio [I(Ti)/I(Mg)] of the metal oxide layer is 0.05 or more.

The base material may further contain one or more of Ti and V in an amount of 0.002 to 0.01 wt % alone or as a mixture.

The base material may further contain 0.01 to 0.05 wt % of Sb, 0.03 to 0.1 wt % of Sn, and Cr, and may satisfy the following Expression 2.

### [Expression 2]

[Sb]≤[Cr]≤[Sb]+2×[Sn]
   (In Expression 2, [Sb], [Cr], and [Sn] represent contents (wt %) of Sb, Cr, and Sn in the base material, respectively.)

Whiteness of the grain-oriented electrical steel sheet may be 43 to 51.

The metal oxide layer may contain 0.003 wt % or more of Ti.

The grain-oriented electrical steel sheet may further include an insulating coating layer located on the metal oxide layer, and a ratio of the sum of thicknesses of the metal oxide layer and the insulating coating layer to the total thickness of the grain-oriented electrical steel sheet may be 0.03 or less.

### Advantageous Effects

In the grain-oriented electrical steel sheet according to an exemplary embodiment of the present invention, a ratio of the hysteretic loss to the total iron loss may be dramatically reduced by controlling the exposure time to the nitriding gas during the primary recrystallization annealing, and ultimately, the total iron loss may be reduced.

### Mode for Invention

The terms “first”, “second”, “third”, and the like are used to describe various parts, components, regions, layers, and/or sections, but are not limited thereto. These terms are only used to differentiate a specific part, component, region, layer, or section from another part, component, region, layer, or section. Accordingly, a first component, part, region, layer, or section which will be described hereinafter may be referred to as a second component, part, region, layer, or section without departing from the scope of the present invention.

Terminologies used herein are to mention only a specific exemplary embodiment, and are not to limit the present invention. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

When any part is positioned “on” or “above” another part, it means that the part may be directly on or above the other part or another part may be interposed therebetween. In contrast, when any part is positioned “directly on” another part, it means that there is no part interposed therebetween.

Unless defined otherwise, all terms including technical terms and scientific terms used herein have the same meanings as understood by those skilled in the art to which the present invention pertains. Terms defined in a generally used dictionary are additionally interpreted as having the meanings matched to the related technical document and the currently disclosed contents, and are not interpreted as ideal or very formal meanings unless otherwise defined.

In addition, unless otherwise stated, % means wt %, and 1 ppm is 0.0001 wt %.

In an exemplary embodiment of the present invention, the meaning of “further containing an additional element” means that the additional element is substituted for a balance of iron (Fe) by the amount of additional element added.

Hereinafter, exemplary embodiments of the present invention will be described in detail so that those skilled in the art to which the present invention pertains may easily practice the present invention. However, the present invention may be implemented in various different forms and is not limited to exemplary embodiments described herein.

A method for manufacturing a grain-oriented electrical steel sheet according to an exemplary embodiment of the present invention includes: manufacturing a hot-rolled sheet by hot rolling a slab containing, by wt %, 2.5 to 4.0% of Si, 0.03 to 0.09% of C, 0.015 to 0.040% of Al, 0.04 to 0.15% of Mn, 0.01% or less (excluding 0%) of S, 0.002 to 0.012% of N, 0.01 to 0.05% of Sb, 0.03 to 0.1% of Sn, 0.05 to 0.2% of Cr, and a balance of Fe and inevitable impurities; manufacturing a cold-rolled sheet by cold rolling the hot-rolled sheet; subjecting the cold-rolled sheet to primary recrystallization annealing; and subjecting the steel sheet subjected to the primary recrystallization annealing to secondary recrystallization annealing.

Hereinafter, each step will be described in detail.

First, a hot-rolled sheet is manufactured by hot rolling a slab.

Hereinafter, slab alloy components will be described.

A slab contains, by wt %, 2.5 to 4.0% of Si, 0.03 to 0.09% of C, 0.015 to 0.040% of Al, 0.04 to 0.15% of Mn, 0.01% or less (excluding 0%) of S, 0.002 to 0.012% of N, 0.01 to 0.05% of Sb, 0.03 to 0.1% of Sn, 0.05 to 0.2% of Cr, and a balance of Fe and inevitable impurities.

Si: 2.50 to 4.00 wt %

Silicon (Si) serves to reduce core loss, that is, iron loss by increasing resistivity of a grain-oriented electrical steel sheet material. When a content of Si is too low, the resistivity is reduced, such that iron loss may be deteriorated. When the content of Si is too high, brittleness of steel increases, and toughness decreases, such that a sheet breakage rate may increase during a rolling process, weldability may be deteriorated, a load may be produced on a cold rolling operation, a sheet temperature required for pass aging during cold rolling may be insufficient, and formation of secondary recrystallized grains may become unstable. Therefore, the content of Si may be 2.5 to 4.0 wt %. More specifically, the content of Si may be 3.0 to 3.5 wt %.

C: 0.030 to 0.090 wt %

Carbon (C) is an element that induces formation of an austenite phase. An increase in content of C activates ferrite-austenite phase transformation during a hot rolling process, and increases a long stretched hot-rolled band structure formed during the hot rolling process, such that ferrite grain growth during a hot-rolled sheet annealing process is inhibited. In addition, as the content of C increases, a stretched hot-rolled band structure which has higher strength than a ferrite structure increases, and initial particles of a hot-rolled sheet annealed structure, which is a cold-rolled initial structure, are refined, resulting in improvement of a texture after cold rolling, particularly, an increase in Goss fraction. It is considered that a residual C present in the steel sheet after annealing the hot-rolled sheet increases the pass aging effect during cold rolling, and thus increases the Goss fraction in primary recrystallized grains. Therefore, a higher content of C may be better, but after that, during decarburization annealing, a decarburization annealing time becomes longer and productivity is impaired, and when the decarburization at the initial stage of heating is not sufficient, the primary recrystallized grains will be non-uniform, which makes the secondary recrystallization unstable. In addition, since magnetic properties may be deteriorated due to a magnetic aging phenomenon, the content of C may be limited to a range of 0.03 to 0.09 wt %. More specifically, C may be contained in an amount of 0.050 to 0.070 wt %. As described above, carbon is removed by the decarburization during the primary recrystallization annealing, and a base material of a finally manufactured grain-oriented electrical steel sheet may contain 0.005 wt % or less of C. Still more specifically, the base material of the finally manufactured grain-oriented electrical steel sheet may contain 0.003 wt % or less of C.

Al: 0.015 to 0.040 wt %

Aluminum (Al) combines with N and precipitates into AlN. However, in annealing in which decarburization and nitriding are performed, aluminum forms nitrides in the form of (Al, Si, Mn)N and AlN, which are fine precipitates, and plays a role in inhibiting strong grain growth. A certain amount or more of Al that is solid-dissolved is required. When the content of Al is too low, the number and volume fraction of precipitates to be formed are low, and thus, an effect of inhibiting the grain growth may be insufficient. When Al is excessively contained, precipitates coarsely grow and the effect of inhibiting the grain growth is deteriorated. Therefore, Al may be contained in an amount of 0.015 to 0.040 wt %. More specifically, Al may be contained in an amount of 0.0200 to 0.0380 wt %.

Mn: 0.040 to 0.150 wt %

Manganese (Mn), similar to Si, has an effect of increasing the resistivity to reduce the iron loss, and is an element that is important in inhibiting the growth of primary recrystallized grains to cause the secondary recrystallization by reacting with nitrogen, which is introduced by nitriding together with Si, to form precipitates of (Al, Si, Mn)N. In addition, Mn forms surfide precipitates with Cu to improve primary recrystallization grain uniformity, and plays a part as an auxiliary inhibitor in the formation of secondary recrystallized grains. However, when Mn is excessively contained, a slab reheating temperature needs to be increased to adjust (Cu, Mn)S fine precipitates, and in this case, the primary recrystallized grains become extremely fine, and thus, a temperature of the primary recrystallization annealing needs to be increased to be higher than the range, which causes non-uniformity of the grains. Therefore, an upper limit of Mn may be limited to 0. 15 wt %.

In addition, when Mn is excessively added, large amounts of (Fe, Mn) and Mn oxides in addition to Fe₂SiO₄ are formed on a surface of the steel sheet, such that formation of a base coating to be formed during the secondary recrystallization annealing is inhibited, which causes deterioration of the surface quality and the non-uniformity of the phase transformation between ferrite and austenite in the primary recrystallization annealing process, and thus, the size of the primary recrystallized grain becomes non-uniform. As a result, the secondary recrystallization becomes unstable. More specifically, Mn may be contained in an amount of 0.050 to 0.100 wt %.

N: 0.0020 to 0.0120 wt %

Nitrogen (N) is an element that reacts with Al and the like to make grains fine. When these elements are properly distributed, as described above, the structure becomes appropriately fine after cold rolling, which helps to secure an appropriate particle size of primary recrystallized grain, but when a content of N is too high, the primary recrystallized grains become excessively fine, and as a result, the fine grains increase a driving force for causing grain growth during the secondary recrystallization, and the grains may grow to grains having an undesired orientation, which is not preferable. In addition, when N is excessively added, the primary recrystallized grains become excessively fine, and as a result, an undesirable orientation caused by the fine grains may form secondary recrystallized grains, which may cause deterioration of the magnetic properties. Therefore, N is set to 0.0120 wt % or less. Meanwhile, when the content of N is too low, the primary recrystallization inhibition effect is too weak, such that a stable grain growth inhibition effect may not be obtained. Therefore, N may be contained in the slab in an amount of 0.0020 to 0.0120 wt %. More specifically, N may be contained in an amount of 0.0025 to 0.0100 wt %. Since N is partially removed during a secondary recrystallization annealing process, the base material of the finally manufactured grain-oriented electrical steel sheet may contain 0.005 wt % or less of N. Still more specifically, the base material of the finally manufactured grain-oriented electrical steel sheet may contain 0.003 wt % or less of N.

S: 0.0100 wt % or less

Sulfur(S) is an element having a high solid-solution temperature during hot rolling and severe segregation, and is preferably contained as little as possible, but is one of the impurities inevitably contained during steelmaking. In addition, since S forms (Mn, Cu)S and affects the primary recrystallization uniformity, a content of S may be limited to 0.0100 wt % or less. More specifically, S may be contained in an amount of 0.0010 to 0.0080 wt %. Sb: 0.01 to 0.05 wt %

Antimony (Sb) has an effect of increasing the number of Goss-oriented grain nuclei generated during the cold rolling process and thus increasing a fraction of grains having Goss orientation in a primary recrystallized texture. In addition, Sb segregates at a primary recrystallized grain boundary and increases a secondary recrystallization start temperature of grains having a Goss texture during high-temperature annealing for secondary recrystallization, such that a secondary recrystallized microstructure having excellent integration may be obtained, and a magnetic flux density may be increased. When a content of Sb is too low, it is difficult to exert the effect thereof properly. When the content of Sb is too high, the size of the primary recrystallized grain becomes excessively small and the secondary recrystallization start temperature decreases, such that the magnetic properties may be deteriorated, or the inhibition force against the grain growth may be excessively large, and as a result, secondary recrystallized grains may not be formed. Therefore, Sb may be contained in an amount of 0.01 to 0.05 wt %. More specifically, Sb may be contained in an amount of 0.020 to 0.045 wt %.

Sn: 0.03 to 0.10 wt %

Tin (Sn) is a grain boundary segregation element and is known as a grain growth inhibitor because it is an element that inhibits movement of the grain boundary. In addition, Sn increases the fraction of the Goss-oriented grains in the primary recrystallized texture, such that the number of Goss-oriented nuclei that grow into a secondary recrystallized texture increases. In addition, as Sn is added, the size of the secondary recrystallized texture decreases, such that iron loss of the final product is reduced because eddy current loss decreases as the size of the grain decreases. Meanwhile, Sn plays an important role in inhibiting the grain growth through segregation at the grain boundary, which not only improves the inhibitory effect of inhibiting the grain growth driving force of the fined primary recrystallized microstructure, but also prevents the phenomenon of coarsening of particles that cause the effect of inhibiting growth of grains such as (Al, Si, Mn)N and AlN during the high-temperature annealing process to form the secondary recrystallized texture and reducing the grain growth inhibition ability. When a content of Sn is too low, the addition effect may be insufficient. When the content of Sn is too high, the grain growth inhibition ability excessively increases, and the grain size of the primary recrystallized microstructure needs to be reduced in order to relatively increase the grain growth driving force, and thus, decarburization annealing needs to be performed at a low temperature, which makes it impossible to secure an excellent surface because the content of Sn cannot be controlled into an appropriate oxide layer. In addition, in terms of mechanical properties, brittleness increases due to excessive segregation of grain boundary segregation elements, which may cause the sheet breakage during the manufacturing process. Therefore, Sn may be contained in an amount of 0.03 to 0.10 wt %. More specifically, Sn may be contained in an amount of 0.030 to 0.090 wt %.

Cr: 0.05 to 0.20 wt %

When chromium (Cr), which is an element that promotes oxidation formation, is added within a range, Cr inhibits formation of a dense oxide layer in a surface layer portion and helps to form a fine oxide layer in a depth direction. As an appropriate content of Cr is added along with the addition of Sb and Sn, formation of Fe₂SiO₄ in the surface layer portion of the oxide layer increases, which helps to form the oxide layer in the depth direction.

In addition, the addition of Cr further facilitates formation of the primary recrystallized grains having excellent uniformity. That is, Cr is an element that forms primary recrystallized grains having excellent uniformity and increases magnetism by overcoming the phenomenon of non-uniform primary recrystallized grains due to decarburization and nitriding delayed by increased contents of Sb and Sn. When Cr is added within the content range suggested above depending on the contents of Sb and Sn, the internal oxide layer is formed deeper and a speed of nitriding and decarburization becomes faster, and thus, the effect of adding Sb and Sn in the simultaneous decarburization and nitriding process may be increased. Cr may be contained in an amount of 0.05 to 0.20 wt %. More specifically, Cr may be contained in an amount of 0.10 to 0.15 wt %.

The slab may satisfy the following Expression 2.

### [Expression 2]

[Sb]≤[Cr]≤[Sb]+2×[Sn]
   (In Expression 2, [Sb], [Cr], and [Sn] represent contents (wt %) of Sb, Cr, and Sn in the slab, respectively.)

When chromium (Cr), which is an element that promotes oxidation formation, is added within a range, Cr inhibits formation of a dense oxide layer in a surface layer portion and helps to form a fine oxide layer in a depth direction. As an appropriate content of Cr is added along with the addition of Sb and Sn, formation of Fe₂SiO₄ in the surface layer portion of the oxide layer increases, which helps to form the oxide layer in the depth direction.

In addition, the addition of Cr further facilitates formation of the primary recrystallized grains having excellent uniformity. That is, Cr is an element that forms primary recrystallized grains having excellent uniformity and increases magnetism by overcoming the phenomenon of non-uniform primary recrystallized grains due to decarburization and nitriding delayed by increased contents of Sb and Sn. When Cr is added within the content range suggested above depending on the contents of Sb and Sn, the internal oxide layer is formed deeper and a speed of nitriding and decarburization becomes faster, and thus, the effect of adding Sb and Sn in the simultaneous decarburization and nitriding process may be increased.

When the content of Cr is less than a lower limit of Expression 2, the effect is insufficient, and when the content of Cr exceeds an upper limit of Expression 2, the oxide layer is excessively formed, and thus, the effect is reduced.

The slab may further contain one or more of Ti and V in an amount of 0.002 to 0.010 wt % alone or as a mixture. When the slab contains Ti and V alone, the slab may contain 0.002 to 0.010 wt % of each of Ti and V, and when the slab contains Ti and V simultaneously, the amount of Ti+V may be 0.002 to 0.010 wt %. More specifically, the slab may further contain one or more of Ti and V in an amount of 0.0030 to 0.0070 wt % alone or as a mixture.

Ti: 0.002 to 0.010 wt %

Titanium (Ti) is a strong nitride forming element, becomes TiN in a pre-step of hot rolling to lower the content of N, and finely precipitates to inhibit the grain growth. When Ti is added within an appropriate range, Ti has an effect of inhibiting the grain growth due to the formation of TiN precipitates and reducing a deviation in grain size in a coil due to a reduction of AlN fine precipitates.

V: 0.002 to 0.01 wt %

Vanadium (V), which is a carbide and nitride forming element, finely precipitates and inhibits the grain growth. Addition of V within an appropriate range exhibits an effect of inhibiting the grain growth due to formation of fine precipitates and thus reducing the deviation in grain size in the coil.

The slab may further contain 0.010 to 0.050 wt % of P.

P: 0.010 to 0.050 wt %

Phosphorus (P) is an element that exhibits an effect similar to Sn and Sb, and may play an auxiliary role in segregating at the grain boundary to inhibit the movement of the grain boundary and simultaneously inhibiting the grain growth. In addition, P has an effect of improving a {110}<001> texture in terms of a microstructure. When a content of P is too low, there is no addition effect, and when P is excessively added, brittleness increases, and thus, rollability may be significantly deteriorated. More specifically, P may be contained in an amount of 0.015 to 0.045 wt %.

### Impurity Elements

In addition to the above elements, impurities that are inevitably incorporated, such as Zr, Cu, Ni, and Mo, may be contained. Since Zr, Cu, Ni, Mo, and the like are strong carbonitride-forming elements, it is preferable that these elements are not added as much as possible, and each element needs to be contained in an amount of 0.01 wt % or less.

In addition to the elements described above, the slab contains iron (Fe) as the balance. In an exemplary embodiment of the present invention, the addition of elements other than the alloy components described above is not excluded, and various elements may be contained within a range in which the technical spirit of the present invention is not impaired. In a case where additional elements are further contained, these additional elements are contained by replacing the balance of Fe.

The method for manufacturing a grain-oriented electrical steel sheet may further include, before the manufacturing of the hot-rolled sheet, heating the slab to 1,230° C. or lower. Through this step, the precipitates may be partially dissolved. In addition, a columnar structure of the slab is prevented from growing coarsely and cracks are prevented from occurring in a width direction of the sheet in the subsequent hot rolling process, such that a yielding percentage is improved. When the slab heating temperature is too high, a heating furnace may be repaired due to melting of the surface portion of the slab, and the service life of the heating furnace may be shortened. More specifically, the slab may be heated to 1,130 to 1,200° C. It is also possible to hot roll the slab to be continuously cast as it is, without heating the slab.

In the manufacturing of the hot-rolled sheet, a hot-rolled sheet having a thickness of 1.8 to 2.3 mm may be manufactured by hot rolling.

The method for manufacturing a grain-oriented electrical steel sheet may further include, after the manufacturing of the hot-rolled sheet, annealing the hot-rolled sheet. The annealing of the hot-rolled sheet may be performed by a process of heating the hot-rolled sheet to a temperature of 950 to 1,100° C., soaking the hot-rolled sheet at a temperature of 850 to 1,000° C., and then cooling the hot-rolled sheet.

Next, a cold-rolled sheet is manufactured by cold rolling the hot-rolled sheet.

The cold rolling may be performed by a strong cold rolling once or a plurality of passes. The cold-rolled sheet may be manufactured to have a final thickness of 0.14 to 0.25 mm by providing a pass aging effect through warm rolling at a temperature of 200 to 300° C. at least once during rolling. The cold-rolled sheet is subjected to decarburization, recrystallization of a deformed structure, and a nitriding treatment using nitriding gas during the primary recrystallization annealing process.

Next, the cold-rolled sheet is subjected to primary recrystallization annealing.

In an exemplary embodiment of the present invention, the subjecting of the cold-rolled sheet to the primary recrystallization annealing includes measuring the amount of nitriding of the steel sheet and controlling an exposure time to the nitriding gas during the primary recrystallization annealing according to the measurement result.

The amount of nitriding and the exposure time to the nitriding gas may be controlled to satisfy the following Expression 1.

### [Expression 1]

Δ[N]/Δt≥0.025
(In Expression 1, Δ[N] represents the amount (wt %) of nitriding of the steel sheet after the primary recrystallization annealing, and Δt represents the exposure time (minutes) to the nitriding gas.)

In an exemplary embodiment of the present invention, since the process of measuring the amount of nitriding and then controlling the exposure time to the nitriding gas after the fact is performed, there may be a delay between the steel sheet in which the amount of nitriding is measured and the steel sheet to which the controlled exposure time to the nitriding gas is applied. However, in an exemplary embodiment of the present invention, the primary recrystallization annealing is performed continuously, such that the delay may not substantially occur, and the relationship of Expression 1 may be satisfied in the entire coil.

The amount of nitriding refers to a difference between a content of N in the steel sheet after the primary recrystallization annealing and a content of N in the steel sheet before the primary recrystallization annealing. The amount of nitriding may be measured by a nitrogen analyzer, and the result may be reflected in controlling the exposure time to the nitriding gas. Since a method for measuring the amount of nitriding in real time is not limited and is widely known, a specific description will be omitted.

The amount of nitriding of the steel sheet may be 0.02 to 0.04 wt %. When the amount of nitriding is too small, that is, when the value of the left-hand side of Expression 3 is too large, the ability to inhibit internal grain growth may be insufficient. When the amount of nitriding is too large, a large number of defects such as nitrogen discharge holes may occur, a large number of fine secondary recrystallized grains of 5 mm or less may be formed, and the magnetism may be deteriorated.

Nitriding gas may be used without limitation as long as it is gas that may infiltrate nitrogen into the steel sheet. Specifically, ammonia or nitrogen may be used. Nitriding may be performed through a heat treatment in an ammonia atmosphere and a laser or plasma treatment in a nitrogen atmosphere.

The exposure time to the nitriding gas may be controlled by installing a screen in an annealing furnace to inhibit movement of the atmospheric gas along a direction of movement of the steel sheet and injecting gas so that the atmospheric gas may be controlled differently in a space separated by the screen. In addition, the exposure time to the nitriding gas may be controlled by various methods.

The exposure time to the nitriding gas refers to a time for exposing the steel sheet to an atmosphere containing 1 to 10 vol % of nitriding gas. Except for the exposure time to the nitriding gas, primary recrystallization annealing is performed in an atmosphere containing less than 1.0 vol % of nitriding gas.

The amount of nitriding of the steel sheet is proportional to the exposure time to the nitriding gas, but there are various other variables. For example, there may be variables such as the temperature of the steel sheet and the content of atmospheric gas other than nitriding gas. Even if it is desired to control these variables as much as possible, it is virtually impossible to control these variables equally in the entire coil, and even if the exposure time to the nitriding gas is the same, a deviation in the amount of nitriding may occur. Specifically, the exposure time to the nitriding gas may be 30 seconds to 5 minutes.

When the amount of nitriding is too small compared to the exposure time to the nitriding gas, that is, when the value of Expression 1 is too small, precipitates may not be formed uniformly, and a metal oxide layer may be formed non-uniformly during the secondary recrystallization annealing process. This may cause surface defects and make the magnetism unstable. More specifically, the value of Expression 1 may be 0.025 to 0.05.

The subjecting of the cold-rolled sheet to the primary recrystallization annealing is performed in an atmosphere having an oxidation capacity (PH₂O/PH₂) of 0.5 to 0.8, such that carbon in the steel sheet may be discharged to the outside. The oxidation capacity range described above may be controlled throughout or partially controlled during the subjecting of the cold-rolled sheet to the primary recrystallization annealing. Through this, carbon in the steel sheet may be reduced to 0.005 wt % or less.

The subjecting of the cold-rolled sheet to the primary recrystallization annealing may be performed at a temperature of 800 to 900° C. When the temperature is too low, primary recrystallization may not be performed, or nitriding may not be smoothly performed. When the temperature is too high, the primary recrystallized grains may grow too large, which may cause deterioration of the magnetism.

After the subjecting of the cold-rolled sheet to the primary recrystallization annealing, an oxide layer having an average thickness of 1.6 to 3.2 μm may be present on the surface of the steel sheet. Due to decarburization during the primary recrystallization annealing, an oxide layer is present near the surface of the steel sheet. The oxide layer refers to a region from the surface of the steel sheet to an area where a content of oxygen fluctuates rapidly when the content of oxygen is measured. When the thickness of the oxide layer is too thin, non-uniformity of the magnetism increases. When the thickness of the oxide layer is too thick, a thick metal oxide layer is formed, and the thickness of the base material is relatively reduced, which may cause deterioration of the magnetism.

Next, the cold-rolled sheet subjected to the primary recrystallization annealing is subjected to secondary recrystallization annealing. Broadly speaking, the purpose of the secondary recrystallization annealing is to form a {110}<001> texture by secondary recrystallization, provide insulation by forming a metal oxide layer through a reaction of the oxide layer formed during decarburization and MgO in an annealing separator, and remove impurities that deteriorates magnetic properties. As a method of the secondary recrystallization annealing, in a temperature rise section before the secondary recrystallization occurs, a mixed gas of nitrogen and hydrogen is maintained to protect a nitride, which is a grain growth inhibitor, such that secondary recrystallization may develop well, and after the secondary recrystallization is completed, the nitride is maintained in a 100% hydrogen atmosphere for a long time to remove impurities. During the secondary recrystallization annealing process, nitride precipitates are decomposed and nitrogen is removed by passing through the metal oxide layer, and as nitrogen diffuses into the metal oxide layer, nitrogen reacts with Ti to partially form TiN.

In the secondary recrystallization annealing process, the surface oxide layer formed in the primary recrystallization annealing process reacts with the annealing separator to form a metal oxide layer. The metal oxide layer has components that are distinct from the base material. For example, in a case where MgO is used as an annealing separator, the metal oxide layer contains forsterite. In the present invention, as an annealing separator, a Ti compound is further contained in addition to MgO. More specifically, the annealing separator contains 90 to 99 wt % of MgO and 1 to 10 wt % of a Ti compound as a solid content.

The method for manufacturing a grain-oriented electrical steel sheet may further include, after the secondary recrystallization annealing, forming an insulating coating layer. Since a method for forming the insulating coating layer is widely known, a specific description will be omitted.

In an exemplary embodiment of the present invention, a content of nitrogen is controlled to be sufficiently high compared to the exposure time to the nitriding gas atmosphere, such that after the secondary recrystallization, a thickness of the metal oxide layer may be formed to be thin, and an additional process of removing the metal oxide layer may not be included. Specifically, a ratio of the sum of thicknesses of the metal oxide layer and the insulating coating layer to the total thickness of the grain-oriented electrical steel sheet including the metal oxide layer and the insulating coating layer may be 0.03 or less. More specifically, the ratio may be 0.001 to 0.03.

A grain-oriented electrical steel sheet according to an exemplary embodiment of the present invention includes: a base material containing, by wt %, 2.5 to 4.0% of Si, 0.005% or less (excluding 0%) of C, 0.015 to 0.040% of Al, 0.04 to 0.15% of Mn, 0.01% or less (excluding 0%) of S, 0.005% or less (excluding 0%) of N, 0.01 to 0.05% of Sb, 0.03 to 0.1% of Sn, 0.05 to 0.2% of Cr, and a balance of Fe and inevitable impurities; and a metal oxide layer located on the base material.

Since the steel composition of the base material of the grain-oriented electrical steel sheet has been described in relation to the steel composition of the slab described above, an overlapping description will be omitted. As described above, since decarburization and nitriding are performed during the manufacturing process of the grain-oriented electrical steel sheet, the contents of C and N in the steel composition of the slab and the steel composition of the base material may be different, and the remaining elements may not substantially change.

In an exemplary embodiment of the present invention, a maximum (Max) emission intensity ratio [I(Ti)/I(Mg)] of the metal oxide layer is 0.05 or more. The maximum emission intensity may be measured from a max intensity of Ti and Mg components through elemental analysis of the metal oxide layer in a thickness direction using a glow discharge surface analysis method. In an exemplary embodiment of the present invention, the content of nitrogen is controlled to be sufficiently high compared to the exposure time to the nitriding gas atmosphere, such that localized nitriding concentration in the oxide layer and a lower part of the oxide layer may be suppressed, sufficient nitride precipitates may be formed in the depth direction, and the metal oxide layer formed during the secondary recrystallization annealing is formed densely and uniformly, thereby increasing the maximum emission intensity ratio. A high maximum emission intensity ratio is advantageous for forming a firm metal oxide layer and thus providing uniform tension, and suppresses nitrogen loss before the secondary recrystallized grain formation, which ultimately leads to improved magnetism.

Whiteness of the grain-oriented electrical steel sheet may be 43 to 51. The whiteness may be measured when the insulating coating layer is absent or removed and only the metal oxide layer is present. The whiteness may be measured using a reflectometry method of a spectrocolorimeter, and may be measured by measuring both sides of the coating 10 times or more and taking an average value of the measured values. When the whiteness is too large, the metal oxide layer is formed non-uniformly, surface defects occur, and a magnetic deviation increases. When the whiteness is too small, a thickness ratio occupied by the metal oxide layer becomes too high and the magnetism is rather deteriorated.

The metal oxide layer may contain 0.003 wt % or more of Ti. Ti in the metal oxide layer may be derived from the Ti compound component in the annealing separator, or may be present as a result of diffusion of the Ti component in the steel sheet. When a small amount of Ti is present in the metal oxide layer, the metal oxide layer is formed thin and non-uniform, and problems with coating defects due to the formation of Fe oxide may occur. More specifically, the metal oxide layer may contain 0.003 to 0.02 wt % of Ti. Still more specifically, the metal oxide layer may contain 0.005 to 0.02 wt % of Ti.

In an exemplary embodiment of the present invention, a thickness of the grain-oriented electrical steel sheet may be 0.23 mm or less. More specifically, the thickness of the grain-oriented electrical steel sheet may be 0.20 mm or less. Here, the thickness of the grain-oriented electrical steel sheet refers to the total thickness of all of the base material, the metal oxide layer, and the insulating coating layer.

The grain-oriented electrical steel sheet according to an exemplary embodiment of the present invention has significantly excellent iron loss and magnetic flux density. Specifically, the iron loss (W17/50) may be 0.8 W/kg or less, and a ratio of hysteresis loss to the total iron loss may be 40% or less. In addition, a magnetic flux density (B8) induced under a magnetic field of 800 A/m of the grain-oriented electrical steel sheet may be 1.91 T or more. More specifically, the magnetic flux density (B8) may be 1.91 to 1.97 T.

Hereinafter, preferred Examples and Comparative Examples of the present invention will be described. However, each of the following Examples is merely a preferred example of the present invention, and the present invention is not limited to the following Examples.

### EXAMPLES

Steel materials containing A to H slabs having the component compositions shown in Table 1 and the balance of Fe and other inevitable impurities were vacuum-melted to manufacture ingots, and then the ingots were heated at a temperature of 1,150° C. for 210 minutes and then hot-rolled, thereby manufacturing hot-rolled sheets having a thickness of 2.3 mm or 2.0 mm. After pickling, the steel was cold-rolled once to a thickness of 0.23 mm or 0.20 mm at a reduction ratio of 90%.

The cold-rolled sheet was maintained at a temperature of 850° C. in a 50 v % hydrogen and 50 v % nitrogen humid atmosphere and an ammonia mixed gas atmosphere for 180 seconds and subjected to a simultaneous decarburization, nitriding, and annealing heat treatment so that a content of carbon was 30 ppm or less and the total content of nitrogen was 200 ppm or more.

At this time, within the ammonia gas volume fraction of 1 to 10 vol % and the oxidation capacity (P_{H2O}/P_{H2}) of 0.5 to 0.8, the amount of nitriding after nitrification and the exposure time to ammonia were adjusted to satisfy the conditions as shown in Table 2.

An annealing separator containing 95 wt % of MgO and 5 wt % of TiO₂ as a solid content was applied to the steel sheet, and the steel sheet was subjected to secondary recrystallization annealing into a coil. The secondary recrystallization annealing was performed in a mixed atmosphere of 25 v % nitrogen and 75 v % hydrogen up to 1,200° C., and after reaching 1,200° C., the steel sheet was maintained in a 100% hydrogen atmosphere for 10 hours or longer and then subjected to furnace cooling.

Thereafter, an insulating coating layer forming composition containing a mixed solution of metal phosphate and colloidal silica was applied, and a heat treatment was performed, thereby forming an insulating coating layer.

The whiteness, maximum emission intensity ratio [I(Ti)/I(Mg)], and hysteresis loss ratio measured for each condition are summarized in Table 2. Each measurement method is as follows.

Whiteness: The whiteness was measured using a reflectometry method of a spectrocolorimeter, and was measured by measuring both sides of the coating 10 times or more and taking an average value of the measured values.

Maximum emission intensity ratio [I(Ti)/I(Mg)]: The ratio was measured from a max intensity of Ti and Mg components through elemental analysis of the metal oxide layer in a thickness direction using a glow discharge surface analysis method.

Hysteresis loss ratio: Iron loss and hysteresis loss of the specimen manufactured under each condition were measured and a ratio of the hysteresis loss to the total iron loss was determined.

TABLE 1

| Steel | | | | | | | | | |
|---|---|---|---|---|---|---|---|---|---|
| type | | | | | | | | | |
| (wt %) | Si | C | Mn | P | Al | N | Sb | Sn | Cr |
| A | 3.35 | 0.06 | 0.08 | 0.03 | 0.037 | 0.006 | 0.02 | 0.06 | 0.13 |
| B | 3.4 | 0.055 | 0.09 | 0.02 | 0.037 | 0.005 | 0.02 | 0.09 | 0.15 |
| C | 3.45 | 0.065 | 0.08 | 0.03 | 0.036 | 0.005 | 0.04 | 0.04 | 0.12 |
| D | 3.4 | 0.06 | 0.09 | 0.04 | 0.036 | 0.005 | 0.02 | 0.06 | 0.01 |
| E | 3.45 | 0.065 | 0.08 | 0.03 | 0.036 | 0.005 | 0.02 | 0.03 | 0.13 |
| F | 3.45 | 0.06 | 0.09 | 0.03 | 0.038 | 0.005 | 0.03 | 0.01 | 0.1 |
| G | 3.35 | 0.055 | 0.08 | 0.03 | 0.038 | 0.004 | 0.03 | 0.15 | 0.12 |
| H | 3.35 | 0.06 | 0.08 | 0.03 | 0.038 | 0.004 | 0.07 | 0.05 | 0.12 |

TABLE 2

| | | | | Increased | | | | | | |
|---|---|---|---|---|---|---|---|---|---|---|
| | Cold- | | | amount of | | | | | | |
| | rolled | Increased | Exposure | nitriding | | | Iron | Magnetic | | |
| | sheet | amount of | time to | (wt %)/Exposure | | | loss | flux | Hysteresis | |
| | thickness | nitriding | ammonia | time to ammonia | | I(Ti)/I | (W17/50, | density | loss ratio | |
| Components | (mm) | (wt %) | (min) | (min) | Whiteness | (Mg) | W/kg) | (B8, T) | (%) | Reference |
| A | 0.23 | 0.024 | 0.7 | 0.034 | 48.6 | 0.07 | 0.81 | 1.92 | 37 | Inventive |
| | | | | | | | | | | Steel 1 |
| B | | 0.02 | 0.8 | 0.025 | 45.4 | 0.18 | 0.8 | 1.93 | 36 | Inventive |
| | | | | | | | | | | Steel 2 |
| C | | 0.027 | 0.9 | 0.03 | 50.5 | 0.15 | 0.83 | 1.93 | 36 | Inventive |
| | | | | | | | | | | Steel 3 |
| A | | 0.01 | 0.5 | 0.02 | 52.5 | 0.04 | 0.86 | 1.9 | 41 | Comparative |
| | | | | | | | | | | Steel 1 |
| B | | 0.009 | 0.6 | 0.015 | 55 | 0.02 | 0.88 | 1.89 | 42 | Comparative |
| | | | | | | | | | | Steel 2 |
| C | | 0.015 | 1 | 0.015 | 56 | 0.02 | 0.89 | 1.89 | 42 | Comparative |
| | | | | | | | | | | Steel 3 |
| A | 0.2 | 0.018 | 0.6 | 0.03 | 44.5 | 0.5 | 0.76 | 1.92 | 39 | Inventive |
| | | | | | | | | | | Steel 4 |
| B | | 0.013 | 0.5 | 0.026 | 45 | 0.45 | 0.75 | 1.93 | 38 | Inventive |
| | | | | | | | | | | Steel 5 |
| C | | 0.012 | 0.8 | 0.015 | 53.6 | 0.03 | 0.84 | 1.89 | 45 | Comparative |
| | | | | | | | | | | Steel 4 |
| D | 0.2 | 0.018 | 0.7 | 0.026 | 52.5 | 0.04 | 0.85 | 1.88 | 47 | Comparative |
| | | | | | | | | | | Steel 5 |
| E | | 0.02 | 0.5 | 0.04 | 44.5 | 0.5 | 0.86 | 1.89 | 45 | Comparative |
| | | | | | | | | | | Steel 6 |
| F | | 0.02 | 0.5 | 0.04 | 44.5 | 0.5 | 0.89 | 1.87 | 47 | Comparative |
| | | | | | | | | | | Steel 7 |
| G | | 0.02 | 0.8 | 0.025 | 55 | 0.02 | 0.85 | 1.87 | 49 | Comparative |
| | | | | | | | | | | Steel 8 |
| H | | 0.02 | 0.8 | 0.025 | 56 | 0.02 | 0.87 | 1.88 | 46 | Comparative |
| | | | | | | | | | | Steel 9 |

As shown in Table 1, in the inventive steel in which the exposure time to the nitriding gas was appropriately controlled according to the amount of nitriding, it was confirmed that the maximum emission intensity ratio [I(Ti)/I(Mg)] was large, the magnetism was excellent, and in particular, the hysteresis loss ratio was small, and thus, the overall iron loss was reduced.

On the other hand, in Comparative Steels 1 to 4 in which the exposure time to the nitriding gas was not appropriately controlled, it was confirmed that the maximum emission intensity ratio [I(Ti)/I(Mg)] was small, and the magnetism was deteriorated.

In Comparative Steels 5 to 9 in which the contents of Sb, Sn, and Cr were not appropriately controlled, it was confirmed that the magnetism was deteriorated even when the exposure time to the nitriding gas was appropriately controlled.

The present invention is not limited to the exemplary embodiments, but may be prepared in various different forms, and it will be apparent to those skilled in the art to which the present invention pertains that the exemplary embodiments may be implemented in other specific forms without departing from the spirit or essential feature of the present invention. Therefore, it is to be understood that the exemplary embodiments described hereinabove are illustrative rather than restrictive in all aspects.

1. A method for manufacturing a grain-oriented electrical steel sheet, the method comprising:
manufacturing a hot-rolled sheet by hot rolling a slab containing, by wt %, 2.5 to 4.0% of Si, 0.03 to 0.09% of C, 0.015 to 0.040% of Al, 0.04 to 0.15% of Mn, 0.01% or less (excluding 0%) of S, 0.002 to 0.012% of N, 0.01 to 0.05% of Sb, 0.03 to 0.1% of Sn, 0.05 to 0.2% of Cr, and a balance of Fe and inevitable impurities;
manufacturing a cold-rolled sheet by cold rolling the hot-rolled sheet;
subjecting the cold-rolled sheet to primary recrystallization annealing; and
subjecting the steel sheet subjected to the primary recrystallization annealing to secondary recrystallization annealing,
wherein the subjecting of the cold-rolled sheet to the primary recrystallization annealing includes:
measuring the amount of nitriding of the steel sheet after the primary recrystallization annealing; and
controlling an exposure time to nitriding gas during the primary recrystallization annealing according to the measured amount of nitriding, and
the amount of nitriding and the exposure time to the nitriding gas satisfy the following Expression 1:
[Expression 1]
Δ[N]/Δt≥0.025
(in Expression 1, Δ[N] represents the amount (wt %) of nitriding of the steel sheet after the primary recrystallization annealing, and Δt represents the exposure time (minutes) to the nitriding gas).

2. The method of claim 1, wherein:
the slab further contains one or more of Ti and V in an amount of 0.002 to 0.01 wt % alone or as a mixture.

3. The method of claim 1, wherein:
the slab satisfies the following Expression 2:
[Expression 2]
[Sb]≤[Cr]≤[Sb]+2×[Sn]
(in Expression 2, [Sb], [Cr], and [Sn] represent contents (wt %) of Sb, Cr, and Sn in the slab, respectively).

4. The method of claim 1, wherein:
the subjecting of the cold-rolled sheet to the primary recrystallization annealing is performed in an atmosphere having an oxidation capacity (PH₂O/PH₂) of 0.5 to 0.8.

5. The method of claim 1, wherein:
the subjecting of the cold-rolled sheet to the primary recrystallization annealing is performed at a temperature of 800 to 900° C.

6. The method of claim 1, wherein:
after the subjecting of the cold-rolled sheet to the primary recrystallization annealing, an oxide layer having an average thickness of 1.6 to 3.2 μm is present on a surface of the steel sheet.

7. The method of claim 1, wherein:
after the subjecting of the cold-rolled sheet to the primary recrystallization annealing, the amount of nitriding of the steel sheet is 0.02 to 0.04 wt %.

8. A grain-oriented electrical steel sheet comprising:
a base material containing, by wt %, 2.5 to 4.0% of Si, 0.005% or less (excluding 0%) of C, 0.015 to 0.040% of Al, 0.04 to 0.15% of Mn, 0.01% or less (excluding 0%) of S, 0.005% or less (excluding 0%) of N, 0.01 to 0.05% of Sb, 0.03 to 0.1% of Sn, 0.05 to 0.2% of Cr, and a balance of Fe and inevitable impurities; and
a metal oxide layer located on the base material,
wherein a maximum emission intensity ratio [I(Ti)/I(Mg)] of the metal oxide layer is 0.05 or more.

9. The grain-oriented electrical steel sheet of claim 8, wherein:
the base material further contains one or more of Ti and V in an amount of 0.002 to 0.01 wt % alone or as a mixture.

10. The grain-oriented electrical steel sheet of claim 8, wherein:
the base material satisfies the following Expression 2:
[Expression 2]
[Sb]≤[Cr]≤[Sb]+2×[Sn]
(in Expression 2, [Sb], [Cr], and [Sn] represent contents (wt %) of Sb, Cr, and Sn in the base material, respectively).

11. The grain-oriented electrical steel sheet of claim 8, wherein:
whiteness of the grain-oriented electrical steel sheet is 43 to 51.

12. The grain-oriented electrical steel sheet of claim 8, wherein:
the metal oxide layer contains 0.003 wt % or more of Ti.

13. The grain-oriented electrical steel sheet of claim 8, further comprising an insulating coating layer located on the metal oxide layer,
wherein a ratio of the sum of thicknesses of the metal oxide layer and the insulating coating layer to the total thickness of the grain-oriented electrical steel sheet is 0.03 or less.
